(19) United States
(12) Patent Application Publication
(10) Pub. No.: US 2008/0312999 A1
(43) Pub. Date: Dec. 18, 2008

(54) Multiple Goal Throughput Analysis

(75) Inventors: Arthur R. Greef, Burien, WA (US); Steen Sloth Christensen, Greve (DK); Per Vikkelsoe, Frederiksvaerk (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/762,676

(22) Filed: Jun. 13, 2007

(51) Int. Cl. G05B 19/418

(52) U.S. Cl. 705/8

(57) ABSTRACT

A method of analyzing production throughput is disclosed. The method may define production constraints, define timing constraints, define resource constraints, add a weight to one or more solution strategies for the production throughput and calculate a production throughput solution to satisfy the constraints and the weighted solution strategies and report the calculated production throughput solution.

### BACKGROUND

This Background is intended to provide the basic context of this patent application and it is not intended to describe a specific problem to be solved.

The need to be able to flexibly plan the production of goods or the provision of services has long been present. Linear programming has been able to provide optimal solutions to production situations that are capable of being broken down into a series of mathematical equations. These equations can be quite complex. However, users often have more than a single goal when planning production. For example, while maximizing profit is always nice, it may place excessive demands on workers and suppliers that cannot be sustained over a long period of time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of analyzing production throughput is disclosed. The method may define production constraints, define timing constraints, define resource constraints, add a weight to one or more solution strategies for the production throughput and calculate a production throughput solution to satisfy the constraints and the weighted solution strategies and report the calculated production throughput solution. The constraints and strategies may be reduced to a series of equations with variables that are maximized or minimized. As a result, goals are maximized or minimized while respecting the constraints that are part of the throughput system.

### DRAWINGS

FIG. 1 is a block diagram of a computing system that may operate in accordance with the claims;

FIG. 2 is an illustration of a method of analyzing throughput with multiple goals;

FIG. 3 is an illustration of goals that are satisfied to meet the chase strategy of throughput planning;

FIG. 4 is an illustration of goals that are satisfied to meet the level strategy of throughput planning; and

FIG. 5 is an illustration of goals that are satisfied to meet the profit strategy of throughput planning.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

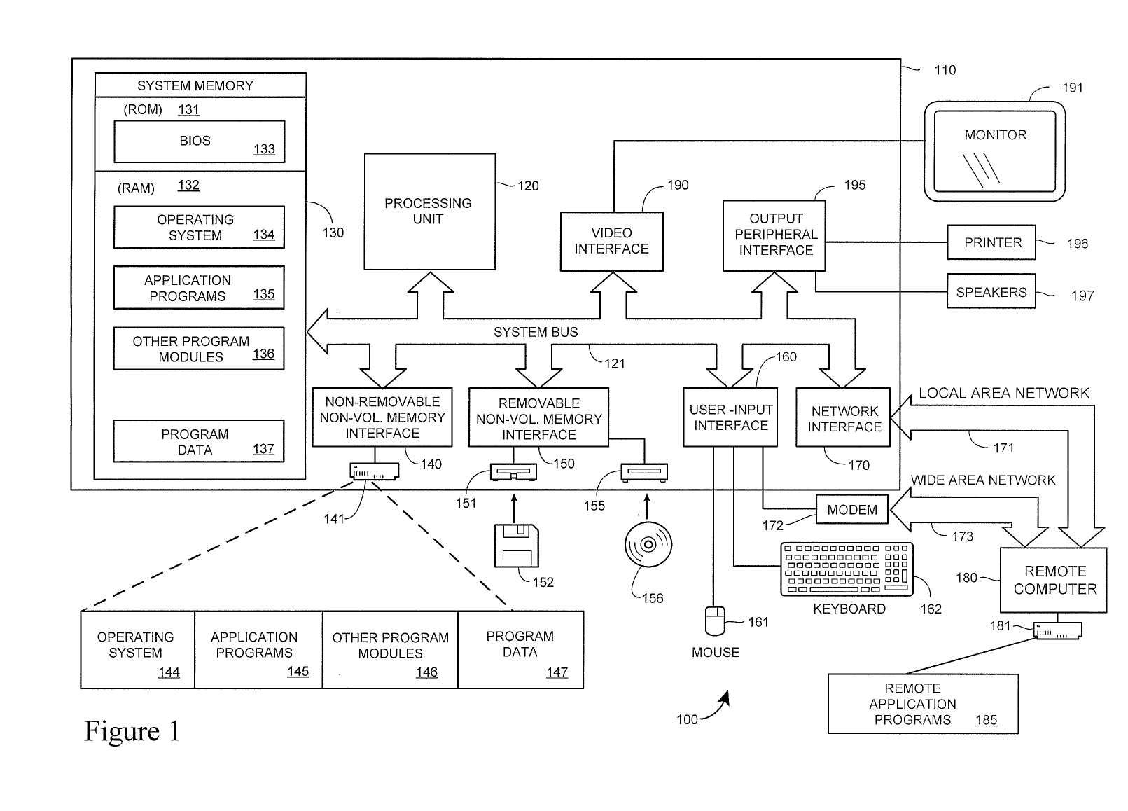

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and the Peripheral Component Interconnect-Express (PCI-E).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

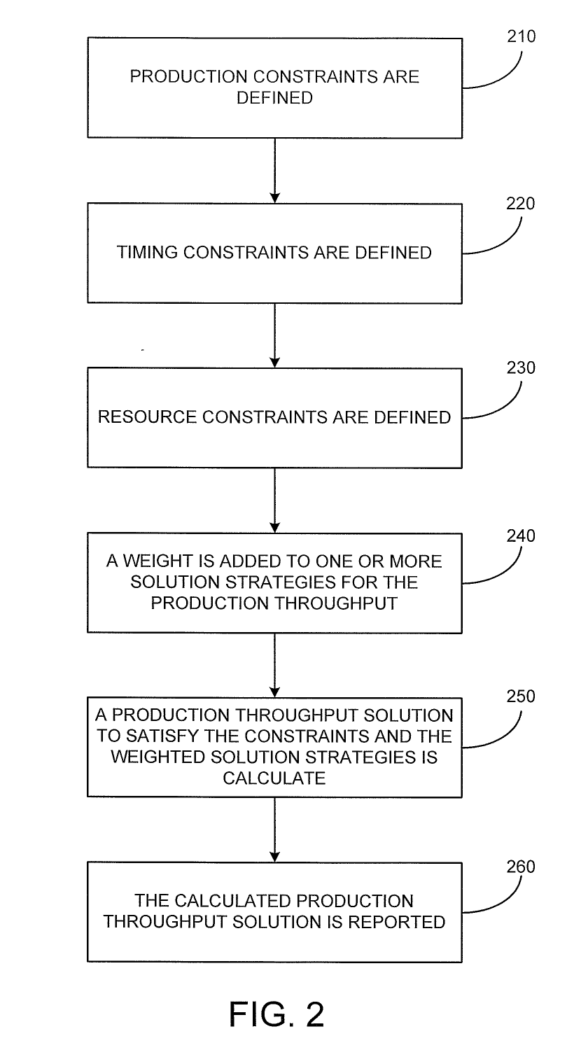

FIG. 2 illustrates a method of analyzing production throughput. The method is an abstract representation of material and work flow in multi-site production and logistics system. The model is formulated as a directed network of material and service capacity flows between production and logistics activities. Raw materials and service capacity are inputted into the system, work-in-process material is transferred between activities in the system and products are output from the system. Production throughput analysis attempts to take into account as many variables as possible in creating a production volume and mix that will satisfy the goals of the producer or service provider. The goals may be simple such as maximize profit or minimize use of materials. However, being able to satisfy a plurality of goals at the same time has been a challenge. In addition, being able to place weights of importance on different goals all of which need to be satisfied (or at least the most important goals are satisfied).

At block 210, production constraints are defined. Production constraints may be elements needed to create a product. For example, a bicycle may require two wheels, one frame, gearing mechanisms, braking mechanisms, a seat, pedals and steering mechanisms. Each of these parts may be delivered whole or may be delivered in pieces which are put together to create the parts.

At block 220, timing constraints are defined. Timing constraints may be an amount of time need to complete each step of the production. For example, it may take one laborer two hours to use the necessary pieces to build one wheel.

At block 230, resource constraints are defined. Resource constraints may be an availability of resources needed to create a product. For example, bicycles need tires. If only a limited number of tires are available, then the number of bikes that can be built is limited. If the tires are readily available, then the availability of tires will not limit the number of bicycles that can be built.

In one embodiment, different weights can be added to at least one of the constraints. For example, it may be especially important to a certain vendor that sufficient time is available to complete a project. A weight may be added to the timing constraint so that additional slack may be built into the solution.

At block 240, a weight is added to one or more solution strategies for the production throughput. -Solution strategies are overall aims that the user desires to be satisfied. Some example of solution strategies include a chase strategy, a level strategy and a profit strategy. Strategies are made up of a set of goals to be maximized or minimized. In order to satisfy the goals, the strategies use a series of equations to calculate a solution. The equations are selected from the group of equations including a time equation, a material flows equation, a service flows equation, an activities equation and a demand equation. The equations may be described as follows:

Time—Each flow (transfer of intermediate product) in a production and logistics system is modeled as a bounded function of discrete time periods in the interval [1, . . . ,time horizon]. Time period 0 is the point in time after which flows are calculated for each time period. The time horizon index is the last time period for which the model will calculate material flows. Time is a parameter and decision variable index in the model.

Material Flows—A material flow [1 . . . M] in the model is a rate-based flow that represents the quantity of storable raw material, work-in-process and product that flows in the system each time period. The flows calculated at the end of each time period in the model is the cumulative material flows that occur during the time period i.e. from the start of the time period until the end of the time period. A material balance, due to the physical law of mass conservation, exists between material in transit, received, applied, output and sent to an activity. Cumulative send, receive, input and output material flows are parameters and decision variables in the model.

Service Flows—A service flow [1 . . . S] in the model is a rate-based non-storable flow of work capacity. Service capacity is allocated to activities and applied to the production of output materials. A service capacity limit exists between allocated and applied capacity due to the physical law of work conservation. Cumulative activity input service flows are decision variables in the model.

Activities—Each activity [1 . . . N] in the model is a production or logistics activity. The 0^{th} activity is a virtual activity that represents a supply of raw material into the system. The N+1 activity is also a virtual activity that represents a delivery of final product out of the system.

The variables used in the equations include:

Inventory levels at a point in time;

Backlog of demand in a time period;

Activity intensity, wherein activity intensity represents the work required to produce the required inventory of intermediate materials and final product in each time period;

Raw material input, wherein raw material input represents the raw material that must be inputted into the system each time period;

Product output, wherein the product output represents that output from the system during each time period;

Goal overachievement wherein goal overachievement represents that amount by which a solution to the problem over achieves the goal value;

Goal underachievement wherein goal underachievement represents that amount by which a solution to the problem under achieves the goal value;

Cumulative raw material cost, wherein the cumulative raw material cost is the cost of the raw material needed to produce the final product output;

Cumulative raw material sales revenue, wherein the cumulative raw material sales revenue is the revenue generated from the sale of the final product output;

Activity intensity goal, wherein the activity intensity goal is the sum of the difference between maximum activity intensity goal and minimum activity intensity goal for each activity at each time period;

Profit goal, wherein profit goal is the product revenue minus total variable cost of material;

Demand satisfaction goal, wherein demand satisfaction goal is satisfied if final output product flow is sufficient to satisfy the known demand; and

Material transit goal, wherein the material transit goal is a heuristic used to govern material flow between operational sites and between operational sites and market demand points.

At block 250, a production throughput solution to satisfy the constraints and the weighted solution strategies is calculated. Multiple equations are created to satisfy the constraints through linear programming.

Inventory can be reduced to a set of equations which can be solved through linear programming to obtain an optimal result. The following are some sample inventory equations:

$${Inventory}_{time}^{site , material} = {Inventory}_{time - 1}^{site , material} + \{ \begin{matrix}{\sum }_{activity} {CoefficientMaterialOutputConstant}_{activity , time}^{site , material} {ActivityIntensity}_{activity , time - {LugAfter}_{activity , time}^{site}}^{site} & if time > {LagAfter}_{activity , time}^{site} \\ {\sum }_{activity} {ParamKnownMaterialOutput}_{activity , time}^{site , material} & for 0 < time \leq {LagAfter}_{activity , time}^{site}\end{matrix} + \{ \begin{matrix}{RawMaterialInput}_{time - {LagBefore}_{time}^{site , material}}^{site , material} & if time > {LagBefore}_{time}^{site , material} \\ {ParamKnownRawMaterialInput}_{time}^{site , material} & for 0 < time \leq {LagBefore}_{time}^{site , material}\end{matrix} + \{ \begin{matrix}{\sum }_{fromsite} {MaterialTransfer}_{site , time - {LagBefore}_{site , time}^{fromsite , material}}^{fromsite , material} & if time > {LagBefore}_{site , time}^{fromsite , material} \\ {\sum }_{fromsite} {ParamKnownMaterialTransfer}_{site , time}^{fromsite , material} & for 0 < time \leq {LagBefore}_{site , time}^{fromsite , material}\end{matrix} - {\sum }_{activity} \{ \begin{matrix}{CoefficientMaterialInputConstant}_{activity}^{site , material} {ActivityIntensity}_{activity , time}^{site} & if time \leq timehorizon - {LagAfter}_{activity , time}^{site} \\ 0 & if time > timehorizon - {LagAfter}_{activity , time}^{site}\end{matrix} - {\sum }_{market} \{ \begin{matrix}{ProductOutput}_{market , time}^{site , material} & if time \leq timehorizon - {LagBefore}_{market , time}^{site , material} \\ 0 & if time > timehorizon - {LagBefore}_{market , time}^{site , material}\end{matrix} - {\sum }_{tosite} \{ \begin{matrix}{MaterialTransfer}_{tosite , time}^{site , material} & if time \leq timehorizon - {LagBefore}_{tosite , time}^{site , material} \\ 0 & if time > timehorizon - {LagBefore}_{tosite , time}^{site , material}\end{matrix} \\ all site , material , \\ all time > 0 \\ tosite \neq site \\ fromsite \neq site$$

Related, the provision of services can be reduced to a series of equations. The conservation of service equation limits the amount of capacity that activities can apply to the production of material output.

$${\sum }_{activity} {CoefficientServiceInputConstant}_{activity , time}^{site , service} {ActivityIntensity}_{activity , time}^{site} \leq {ParamServiceCapacity}_{time}^{site , service}$$

$$all site , service$$

$$all time > 0$$

A demand goal equations may be as follows:

$${ParamKnownDemand}_{time}^{market , material} = \{ \begin{matrix}{\sum }_{site} {ProductOutput}_{market , time - {LagBefore}_{market , time}^{site , material}}^{site , material} & if time > {LagBefore}_{market , time}^{site , material} \\ {ParamKnownProductOutput}_{material , time}^{site , material} & for 0 < time \leq {LagBefore}_{market , time}^{site , material}\end{matrix} + {KnownDemandGoal}_{time}^{ - market , material} - {KnownDemandGoal}_{time}^{ + market , material} \\ all market , material \\ all time > 0 \\ DemandSatisfactionGoal = {\sum }_{market , material , time} {KnownDemandGoal}_{time}^{ - market , material} \\ time > 0$$

The inventory goal equation has a zero inventory objective at all sites An inventory goal equation may be as follows:

$$0 = {\sum }_{site , material , time} ( {Inventory}_{time}^{site , material} ) - {InventoryGoal}^{ +}$$

$$time > 0$$

The backlog goal equation has a zero backlog objective for all markets. A sample backlog equation may be as follows:

$${ParamForecastDemand}_{time}^{market , material} = \{ \begin{matrix}{\sum }_{site} {ProductOutput}_{market , time - {LagBefore}_{market , time}^{site , material}}^{site , material} & if time > {LagBefore}_{market , time}^{site , material} \\ {ParamKnownProductOutput}_{market , time}^{site , material} & for 0 < time \leq {LagBefore}_{market , time}^{site , material}\end{matrix} - {Backlog}_{time - 1}^{market , material} + {Backlog}_{time}^{market , material} \\ all market , material \\ all time > 0 \\ 0 = {\sum }_{market , material , time} ( {Backlog}_{time}^{market , material} ) - {BacklogGoal}^{ +} \\ time > 0$$

The production rate goal has a level activity intensity objective. A sample production rate goal equation may be as follows:

$$( 1 + CoefficientMargin ) {ActivityIntensity}_{activity , time - 1}^{site} = {ActivityIntensity}_{activity , time}^{site} + {MaxIntensityGoal}_{activity , time}^{- site} - {MaxIntensityGoal}_{activity , time}^{ + site}$$

$$all site , activity$$

$$all time > 1$$

$$( 1 - CoefficientMargin ) {ActivityIntensity}_{activity , time - 1}^{site} = {ActivityIntensity}_{activity , time}^{site} + {MinIntensityGoal}_{activity , time}^{ - site} - {MinIntensityGoal}_{activity , time}^{ + site}$$

$$all site , activity$$

$$all time > 1$$

$$ActivityIntensityGoal = {\sum }_{{site ,}_{{activity ,}_{time}}} ( {MaxIntensityGoal}_{activity , time}^{ + site} + {MinIntensityGoal}_{activity , time}^{ - site} )$$

$$time > 0$$

The profit goal has an objective to maximize cumulative profit over the time horizon where profit is calculated as the revenue generated from sales minus the cost of raw materials. Sample profit goal equations are as follows:

$${CumulativeRawMaterialCost}_{time} = {\sum }_{site , material} ( \{ \begin{matrix}{RawMaterialInput}_{time - {LagBefore}_{time}^{site , material}}^{site , material} & if time > {LagBefore}_{time}^{site , material} \\ {ParamKnownRawMaterialInput}_{time}^{site , material} & for 0 < time \leq {LagBefore}_{time}^{site , material}\end{matrix} ) {CoefficientRawMaterialCost}_{time}^{site , material} + \{ \begin{matrix}0 & if time - 1 = 0 \\ {CumulativeRawMaterialCost}_{time - 1} & for time - 1 > 0\end{matrix} \\ all time > 0 \\ {CummulativeProductSalesRevenue}_{time} = {\sum }_{market , material} ( \{ \begin{matrix}{\sum }_{site} {ProductOutput}_{market , time - {LagBefore}_{market , time}^{site , material}}^{site , material} & if time > {LagBefore}_{market , time}^{site , material} \\ {ParamKnownProductOutput}_{market , time}^{site , material} & for 0 < time \leq {LagBefore}_{market , time}^{site , material}\end{matrix} ) {CoefficientProductSalesPrice}_{time}^{market , material} + \{ \begin{matrix}0 & if time - 1 = 0 \\ {CummulativeProductSalesRevenue}_{time - 1} & for time - 1 > 0\end{matrix} \\ all time > 0 \\ ProfitGoal = {CummulativeProductSalesRevenue}_{timehorizon} - {CummulativeRawMaterialCost}_{timehorizon}$$

The material in transit goal has an objective to minimize the amount of time that material spends in transit both between sites and between sites and markets. Sample material in transit equations are as follows:

$$MaterialIn {Transit}^{site , material} = {\sum }_{fromsite} {MaterialTransfer}_{site , time - {LagBefore}_{site , time}^{fromsite , material}}^{fromsite , material} + {\sum }_{tosite} {MaterialTransfer}_{tosite , time}^{site , material} + {\sum }_{market} {ProductOutput}_{market , time - {LagBefore}_{market , time}^{site}}^{fromsite , material}$$

$$all site , material , \\ all time > 0$$

$$tosite \neq site$$

$$fromsite \neq site$$

$${LagBefore}_{site , time}^{fromsite , material} > 0$$

$${LagBefore}_{market , time}^{site} > 0$$

$$MaterialInTransitGoal = {\sum }_{site , material} {MaterialInTransit}^{site , material}$$

$$all time > 0$$

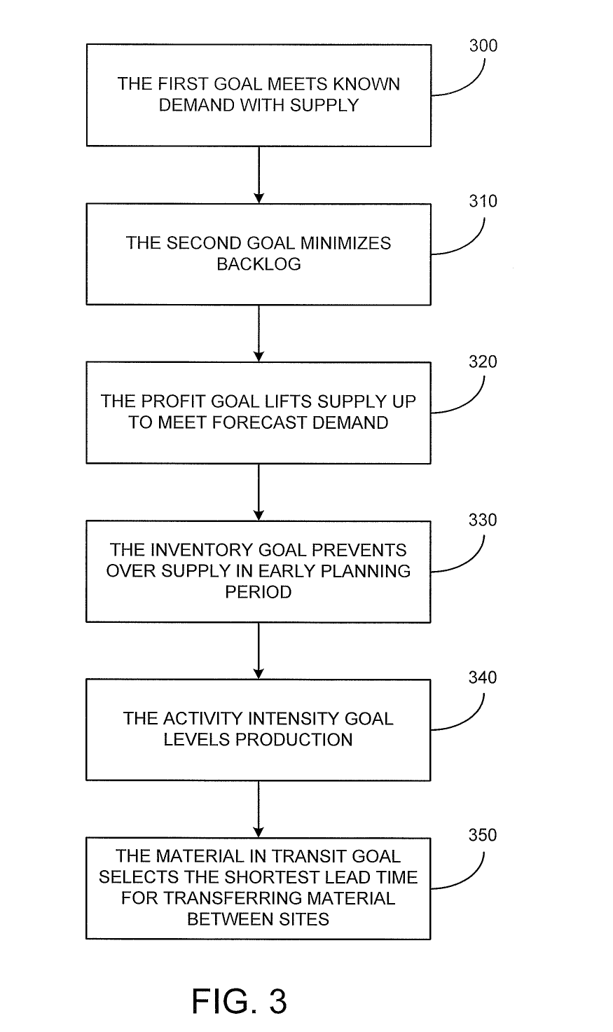

The chase strategy attempts to meet demand with supply. FIG. 3 illustrates the goals and order in which the goals are met. At block 300, the first goal meets known demand with supply. At block 310, the second goal minimizes backlog and at block 320, the profit goal lifts supply up to meet forecast demand. At block 330, the inventory goal prevents over supply in early planning periods and at block 340, the activity intensity goal levels production. At block 350, the material in transit goal selects the shortest lead time for transferring material between sites. Referring to the variables, the chase strategy attempts to:

Maximize the demand satisfaction goal;

Minimize the backlog goal;

Maximize the profit goal;

Minimize the inventory goal;

Minimize the activity intensity goal; and

Minimize the material in transit goal.

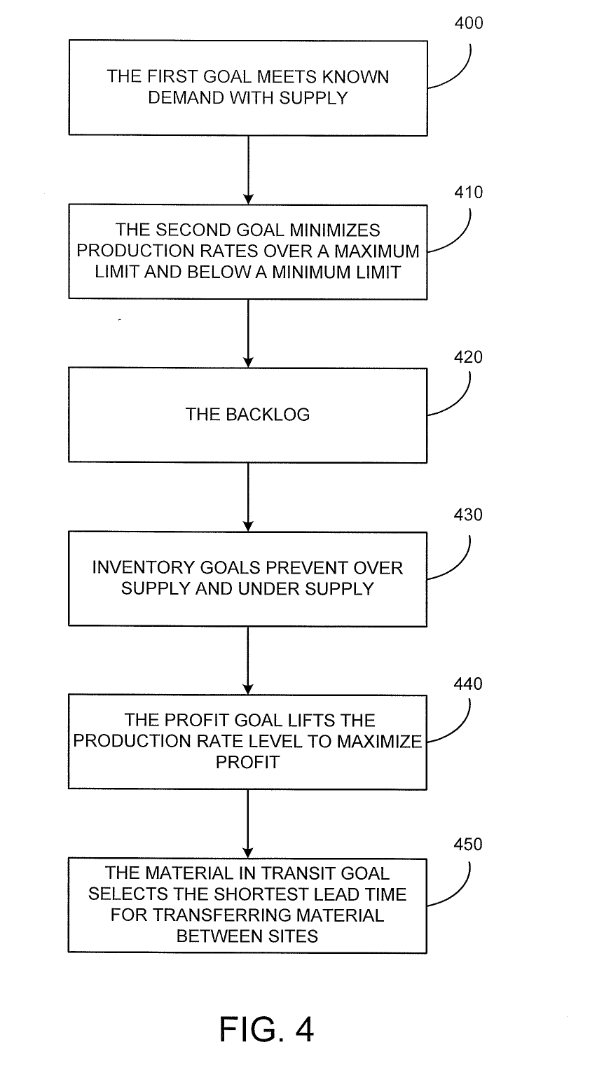

The level strategy attempts to meet variable demand with level production output. FIG. 4 illustrates the goals and order in which the goals are met. At block 400, the first goal meets known demand with supply. At block 410, the second goal minimizes production rates over a maximum limit and below a minimum limit. At block 420, the backlog goal and at block 430, inventory goals prevent over supply and under supply. At block 440, the profit goal lifts the production rate level to maximize profit. At block 450, the material in transit goal selects the shortest lead time for transferring material between sites. Referring to the variables, the level strategy attempts to:

Minimize the demand satisfaction goal;

Minimize the activity intensity goal;

Minimize the backlog goal;

Minimize the inventory goal;

Maximize the profit goal; and

Minimize the material in transit goal.

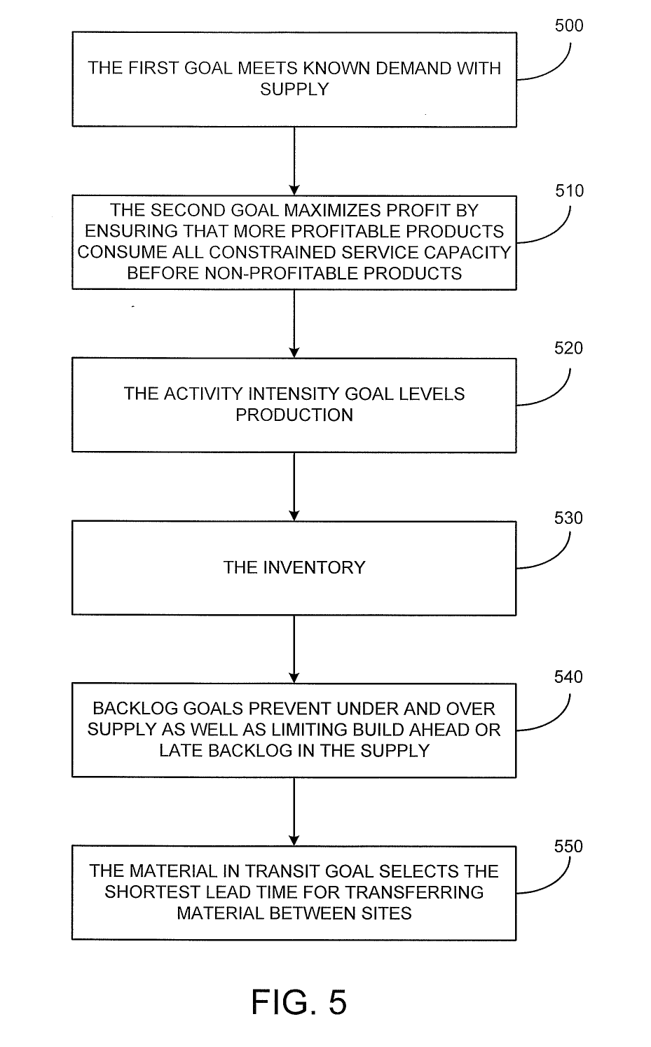

The profit strategy attempts to maximize profit on constrained resources. FIG. 5 illustrates the goals and order in which the goals are met. At block 500, the first goal meets known demand with supply. At block 510, the second goal maximizes profit by ensuring that more profitable products consume all constrained service capacity before non-profitable products. At block 520, the activity intensity goal levels production and the inventory (block 530) and at block 540, backlog goals prevent under and over supply as well as limiting build ahead or late backlog in the supply. At block 550, the material in transit goal selects the shortest lead time for transferring material between sites. Referring to the variables, the profit strategy attempts to:

Minimize demand satisfaction goal;

Maximize profit goal;

Minimize activity intensity goal;

Minimize inventory goal;

Minimize backlog goal; and

Minimize material in transit goal.

Of course, the goals can be switched and placed in different orders to create a variety of different strategies. In addition, different weights may be placed on different goals to add further emphasis to the chosen goals.

Further, more than one strategy may be satisfied at one time. In addition, weights or levels of importance may be placed on strategies.

In use, a topological goal ordering is predefined for the strategies. The goal programming procedure first optimizes a goal and then adds the optimal value as a constraint on the goal before the next goal is optimized. For example, after minimizing InventoryGoal+in the chase production strategy, the InventoryGoal+<=optimal value is added to the model before the ActivityIntensityGoal is minimized.

All the strategies make some assumptions. Specifically,

Inventoryₜᵢₘₑ₌₀^{site,material} Known site inventory levels at the start of the planning calculation.

BackLogₜᵢₘₑ₌₀^{market,material} Known product backlog at the start of the planning calculation.

All decision variations are greater than or equal to zero.

At block 260, the calculated production throughput solution is reported. The solution may be reported as a file, as a printed report, etc.

As an example, Adventure works has three physical operational sites (AW Parts, AW Bike and AW Warehouse) that make and distribute one product—bike frames. The bike frame tubes are cut from pipe at the AW Parts factory and transferred to the AW Bike factory where they are welded into bike frames. The bike frames are transferred to AW Warehouse. There are capacity constraints on the work centers used to cut pipe into tubes and to weld the final bike frame output product. Assume that the transportation between sites is instantaneous.

The inputs into the equations may be as follows:

Indexes created from data in site=AWParts, AWBike, AWWarehouse

material=TubePipe, SeatTube, TopTube, DownTube, HeadTube, Frame

time=0 . . . 3

activity=CutSeatTube, CutTop&HeadTube, CutDownTube, WeldFrame

service=CuttingMachine,WeldingStation

| | Material | | Material |
|---|---|---|---|
| | Input | Service Input | Output |
| Activity | Constant | Constant | Constant |
| CutSeatTube | 1 × TubePipe | 4 mins | 4 × SeatTube |
| | | CuttingMachine | |
| CutTop&HeadTube | 1 × TubePipe | 10 mins Cutting | 2 × TopTube |
| | | Machine | 3 × HeadTube |
| CutDownTube | 1 × TubePipe | 2 mins Cutting | 2 × DownTube |
| | | Machine | |
| WeldFrame | 1 × SeatTube | 10 mins | 1 × BikeFrame |
| | 1 × TopTube | WeldingStation | |
| | 1 × DownTube | | |
| | 1 × HeadTube | | |

Service capacity constraints

AWParts:CuttingMachine: 60 mins per time period

AWBike:WeldingStation: 40 mins per time period

The material balance equations would be as follows:

Inventoryₜᵢₘₑ^{AWParts,TubePipe}=Inventoryₜᵢₘₑ₋₁^{AWParts,TubePipe}+RawMaterialInputₜᵢₘₑ^{AWParts,TubePipe}−1ActivityIntensity_{CutSeatTube}^{AWParts}−1ActivityIntensity_{CutTopTube}^{AWParts}−1ActivityIntensity_{CutDownTube}^{AWParts}−1ActivityIntensity_{CutHeadTube}^{AWParts}

Inventoryₜᵢₘₑ^{AWParts,SeatTube}=Inventoryₜᵢₘₑ₋₁^{AWParts,SeatTube}+4ActivityIntensity_{CutSeatTube}^{AWParts}−MaterialTransfer_{AWBike,time}^{AWParts,SeatTube}

Inventoryₜᵢₘₑ^{AWBike,SeatTube}=Inventoryₜᵢₘₑ₋₁^{AWBike,SeatTube}+MaterialTransfer_{AWParts,time}^{AWBike,SeatTube}−1ActivityIntensity_{WeldFrame}^{AWBike}

Inventoryₜᵢₘₑ^{AWParts,TopTube}=Inventoryₜᵢₘₑ₋₁^{AWParts,TopTube}+2ActivityIntensity_{CutTop&HeadTube}^{AWParts}−MaterialTransfer_{AWBike,time}^{AWParts,TopTube}

Inventoryₜᵢₘₑ^{AWBike,TopTube}=Inventoryₜᵢₘₑ₋₁^{AWParts,TopTube}+MaterialTransfer_{AWPart,times}^{AWBike,TopTube}−1ActivityIntensity_{WeldFrame}^{AWBike}

Inventoryₜᵢₘₑ^{AWParts,DownTube}=Inventoryₜᵢₘₑ₋₁^{AWParts,DownTube}+2ActivityIntensity_{CutDownTube}^{AWParts}−MaterialTransfer_{AWBike,time}^{AWParts,DownTube}

Inventoryₜᵢₘₑ^{AWBike,DownTube}=Inventoryₜᵢₘₑ₋₁^{AWBike,SeatTube}+MaterialTransfer_{AWParts,time}^{AWBike,DownTube}−1ActivityIntensity_{WeldFrame}^{AWBike}

Inventoryₜᵢₘₑ^{AWParts,HeadTube}=Inventoryₜᵢₘₑ₋₁^{AWParts,HeadTube}+3ActivityIntensity_{CutTop&HeadTube}^{AWParts}−MaterialTransfer_{AWBike,time}^{AWPart,HeadTube}

Inventoryₜᵢₘₑ^{AWBike,HeadTube}=Inventoryₜᵢₘₑ₋₁^{AWBike,HeadTube}+MaterialTransfer_{AWParts,time}^{AWBike,HeadTube-ActivityIntensity}_{WeldFrame}^{AWBike}

Inventoryₜᵢₘₑ^{AWBike,BikeFrame}=Inventoryₜᵢₘₑ₋₁^{AWBike,BikeFrame}+1ActivityIntensity_{WeldFrame,time}^{AWBike}−MaterialTransfer_{AWWarehouse,time}^{AWBike,BikeFrame}

Inventoryₜᵢₘₑ^{AWWarehouse,BikeFrame}=Inventoryₜᵢₘₑ₋₁^{AWWarehouse,BikeFrame}+MaterialTransfer_{AWBike,time}^{AWWarehouse,BikeFrame}−ProductOutputₜᵢₘₑ^{AWWarehouse,BikeFrame}

Service constraints would then be created as follows:

4ActivityIntensity_{CutSeatTube,time}^{AWParts}+10ActivityIntensity_{CutTop&HeadTube,time}^{AWParts}+2ActivityIntensity_{CutDownTube,time}^{AWParts}≦ParamServiceCapacityₜᵢₘₑ^{AWParts,CuttingMachine}

10ActivityIntensity_{WeldFrame,time}^{AWBike}≦ParamServiceCapacityₜᵢₘₑ^{AWBike,WeldingStation}

Goal equations would then be created and the optimum solution would be found.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of analyzing production throughput comprising:
Defining production constraints;
Defining timing constraints;
Defining resource constraints;
Adding a weight to one or more solution strategies for the production throughput;
Calculating a production throughput solution to satisfy the constraints and the weighted solution strategies; and
Reporting the calculated production throughput solution.

2. The method of claim 1, further comprising adding weights to at least one of the constraints.

3. The method of claim 1, wherein production constraints comprise elements needed to create a product.

4. The method of claim 1, wherein timing constraints comprise an amount of time need to complete each step of the production.

5. The method of claim 1, wherein the resource constraints comprise an availability of resources needed to create a product.

6. The method of claim 1, wherein the solution strategy comprises one selected from the group comprising a chase strategy, a level strategy and a profit strategy.

7. The method of claim 6 wherein a strategy comprises a set of goals to be maximized.

8. The method of claim 1, wherein calculating a production throughput solution to satisfy the constraints and the weighted solution strategies further comprises creating multiple equations that are satisfied through linear programming.

9. The method of claim 8, wherein the equations are selected from the group of equations comprising:
A time equation;
A material flows equation;
A service flows equation;
An activities equation; and
A demand equation.

10. The method of claim 8, wherein variables used in the equations are selected from the group comprising:
Inventory levels at a point in time;
Backlog of demand in a time period;
Activity intensity, wherein activity intensity represents the work required to produce the required inventory of intermediate materials and final product in each time period;
Raw material input, wherein raw material input represents the raw material that must be inputted into the system each time period;
Product output, wherein the product output represents that output from the system during each time period;
Goal overachievement wherein goal overachievement represents that amount by which a solution to the problem over achieves the goal value;
Goal underachievement wherein goal underachievement represents that amount by which a solution to the problem under achieves the goal value;
Cumulative raw material cost, wherein the cumulative raw material cost is the cost of the raw material needed to produce the final product output;
Cumulative raw material sales revenue, wherein the cumulative raw material sales revenue is the revenue generated from the sale of the final product output;
Activity intensity goal, wherein the activity intensity goal is the sum of the difference between maximum activity intensity goal and minimum activity intensity goal for each activity at each time period;
Profit goal, wherein profit goal is the product revenue minus total variable cost of material;
Demand satisfaction goal, wherein demand satisfaction goal is satisfied if final output product flow is sufficient to satisfy the known demand; and
Material transit goal, wherein the material transit goal is a heuristic used to govern material flow between operational sites and between operational sites and market demand points.

11. The method of claim 10, wherein a chase strategy comprises attempting to:
Maximize the demand satisfaction goal;
Minimize the backlog goal;
Maximize the profit goal;
Minimize the inventor goal;
Minimize the activity intensity goal; and
Minimize the material in transit goal.

12. The method of claim 10, wherein a level strategy comprising attempting to:
Minimize the demand satisfaction goal;
Minimize the activity intensity goal;
Minimize the backlog goal;
Minimize the inventory goal;
Maximize the profit goal; and
Minimize the material in transit goal.

13. The method of claim 10, wherein a profit strategy comprises attempting to:
Minimize demand satisfaction goal;
Maximize profit goal;
Minimize activity intensity goal;
Minimize inventory goal;
Minimize backlog goal; and
Minimize material in transit goal.

14. A computer storage medium comprising computer executable instructions for analyzing production throughput, the computer executable instructions comprising instructions for:
Defining production constraints wherein the production constraints comprise elements needed to create a product;
Defining timing constraints wherein the timing constraints comprise an amount of time need to complete each step of the production;
Defining resource constraints wherein the resource constraints comprise an availability of resources needed to create a product;
Adding a weight to one or more solution strategies for the production throughput wherein the solution strategy comprises one selected from the group comprising a chase strategy, a level strategy and a profit strategy and wherein a strategy comprises a set of goals to be maximized;
Calculating a production throughput solution to satisfy the constraints and the weighted solution strategies wherein calculating a production throughput solution to satisfy the constraints and the weighted solution strategies further comprises creating multiple equations that are satisfied through linear programming and wherein the equations are selected from the group of equations comprising:
A time equation;
A material flows equation;
A service flows equation;
An activities equation; and
A demand equation; and
Reporting the calculated production throughput solution.

15. The computer storage medium of claim 14, wherein variables used in the equations are selected from the group comprising:
Inventory levels at a point in time;
Backlog of demand in a time period;
Activity intensity, wherein activity intensity represents the work required to produce the required inventory of intermediate materials and final product in each time period;
Raw material input, wherein raw material input represents the raw material that must be inputted into the system each time period;
Product output, wherein the product output represents that output from the system during each time period;
Goal overachievement wherein goal overachievement represents that amount by which a solution to the problem over achieves the goal value;
Goal underachievement wherein goal underachievement represents that amount by which a solution to the problem under achieves the goal value;
Cumulative raw material cost, wherein the cumulative raw material cost is the cost of the raw material needed to produce the final product output;
Cumulative raw material sales revenue, wherein the cumulative raw material sales revenue is the revenue generated from the sale of the final product output;
Activity intensity goal, wherein the activity intensity goal is the sum of the difference between maximum activity intensity goal and minimum activity intensity goal for each activity at each time period;
Profit goal, wherein profit goal is the product revenue minus total variable cost of material;
Demand satisfaction goal, wherein demand satisfaction goal is satisfied if final output product flow is sufficient to satisfy the known demand; and
Material transit goal, wherein the material transit goal is a heuristic used to govern material flow between operational sites and between operational sites and market demand points.

16. The computer storage medium of claim 14,
Wherein a chase strategy comprises attempting to:
Maximize the demand satisfaction goal;
Minimize the backlog goal;
Maximize the profit goal;
Minimize the inventor goal;
Minimize the activity intensity goal; and
Minimize the material in transit goal, and
wherein a level strategy comprising attempting to:
Minimize the demand satisfaction goal;
Minimize the activity intensity goal;
Minimize the backlog goal;
Minimize the inventory goal;
Maximize the profit goal; and
Minimize the material in transit goal, and
wherein a profit strategy comprises attempting to:
Minimize demand satisfaction goal;
Maximize profit goal;
Minimize activity intensity goal;
Minimize inventory goal;
Minimize backlog goal; and
Minimize material in transit goal.

17. The computer storage medium of claim 14, further comprising computer executable instructions for adding weights to at least one of the constraints.

18. A computer system comprising a processor for executing computer executable instructions, a memory for storing data related to computer executable instructions and an input/output circuit, the computer executable instructions comprising instructions for analyzing production throughput, the computer executable instructions comprising instructions for:
Defining production constraints wherein the production constraints comprise elements needed to create a product;
Defining timing constraints wherein the timing constraints comprise an amount of time need to complete each step of the production;
Defining resource constraints wherein the resource constraints comprise an availability of resources needed to create a product;
Adding a weight to one or more solution strategies for the production throughput wherein the solution strategy comprises one selected from the group comprising a chase strategy, a level strategy and a profit strategy and wherein a strategy comprises a set of goals to be maximized;
Calculating a production throughput solution to satisfy the constraints and the weighted solution strategies wherein calculating a production throughput solution to satisfy the constraints and the weighted solution strategies further comprises creating multiple equations that are satisfied through linear programming and wherein the equations are selected from the group of equations comprising:
A time equation;
A material flows equation;
A service flows equation;
An activities equation; and
A demand equation; and
Reporting the calculated production throughput solution.

19. The computer system of claim 18, wherein variables used in the equations are selected from the group comprising:
Inventory levels at a point in time;
Backlog of demand in a time period;
Activity intensity, wherein activity intensity represents the work required to produce the required inventory of intermediate materials and final product in each time period;
Raw material input, wherein raw material input represents the raw material that must be inputted into the system each time period;
Product output, wherein the product output represents that output from the system during each time period;
Goal overachievement wherein goal overachievement represents that amount by which a solution to the problem over achieves the goal value;
Goal underachievement wherein goal underachievement represents that amount by which a solution to the problem under achieves the goal value;
Cumulative raw material cost, wherein the cumulative raw material cost is the cost of the raw material needed to produce the final product output;
Cumulative raw material sales revenue, wherein the cumulative raw material sales revenue is the revenue generated from the sale of the final product output;
Activity intensity goal, wherein the activity intensity goal is the sum of the difference between maximum activity intensity goal and minimum activity intensity goal for each activity at each time period;
Profit goal, wherein profit goal is the product revenue minus total variable cost of material;
Demand satisfaction goal, wherein demand satisfaction goal is satisfied if final output product flow is sufficient to satisfy the known demand; and
Material transit goal, wherein the material transit goal is a heuristic used to govern material flow between operational sites and between operational sites and market demand points.

20. The computer system of claim 18,
Wherein a chase strategy comprises attempting to:
Maximize the demand satisfaction goal;
Minimize the backlog goal;
Maximize the profit goal;
Minimize the inventor goal;
Minimize the activity intensity goal; and
Minimize the material in transit goal, and
wherein a level strategy comprising attempting to:
Minimize the demand satisfaction goal;
Minimize the activity intensity goal;
Minimize the backlog goal;
Minimize the inventory goal;
Maximize the profit goal; and
Minimize the material in transit goal, and
wherein a profit strategy comprises attempting to:
Minimize demand satisfaction goal;
Maximize profit goal;
Minimize activity intensity goal;
Minimize inventory goal;
Minimize backlog goal; and
Minimize material in transit goal.
